(19) United States
(12) Patent Application Publication
(10) Pub. No.: US 2023/0281693 A1
(43) Pub. Date: Sep. 7, 2023

(54) METHOD FOR GENERATING PERSONALIZED RECOMMENDATION BY OPTIMIZING TRANSACTION MODE FOR A PRODUCT SEARCH

(71) Applicant: SAVEAZY DIGITAL SOLUTIONS PRIVATE LIMITED, Bangalore (IN)

(72) Inventors: Pradeep Venkatasubramanian, Bangalore (IN); Shiv Shankar, Bangalore (IN)

(21) Appl. No.: 18/117,414

(22) Filed: Mar. 4, 2023

(30) Foreign Application Priority Data
Mar. 4, 2022 (IN) 202241011896

(51) Int. Cl. G06Q 30/0601; G06F 40/30; G06F 40/284

(52) U.S. Cl. CPC G06Q 30/0631; G06F 40/284; G06F 40/30

(57) ABSTRACT

Provided is a method for generating personalized recommendation by optimizing transaction mode for a product search is fulfilled in the ongoing description by (a) automatically obtaining products data from disparate product sources using software robotics process automation, (b) extracting contextual attributes using a natural language processing model based on a composite and contextual matching technique, (c) dynamically updating the products data by detecting inconsistency using software robotics defect detection, (d) obtaining, from user devices, a search query for a product, (e) generating a recommendation of transaction mode for the product using a custom machine learning model, wherein the transaction mode is a combination of the transaction channel and a financial instrument of the user and the recommendation is personalized based on partial information of financial instruments of the user, and (f) representing the recommendation for optimizing search of transaction mode for the product.

### BACKGROUND

### Technical Field

The embodiments herein generally relate to artificial intelligence, and more particularly, to a method for generating personalized recommendation by optimizing transaction mode for a product search.

### Description of the Related Art

In today’s digital age, users are oblivious to the real savings potential they have available at their disposal when the intend to purchase a product on a transaction channel on the internet. This is because the information regarding savings potential on a product on the internet is highly disparate, unobvious. The information regarding savings on a product offering may be manipulated in favor of by paid sponsors. Further, plethora of online and offline options of transaction channels (e-commerce websites, retail stores) constantly vary their offers related to various financial instruments (for example bank cards, UPI etc.) held by the users. Hence, the task of searching for a transaction mode, which is a combination of the financial instrument and a transaction channel, personalized to each individual user that maximizes savings for the user remains inconceivable.

As an example, an offer for a financial instrument ‘X’ on a product ‘Y’ is never easily decipherable given a plurality of transaction conditions that include minimum purchase price, customer geo-location, tiered and bundled offers across ranges and further segmented should a customer require equated monthly installments in addition to multiple other variables. A user has to spends numerous hours on arduous research to search for the best transaction mode for a product. Further, there remains a high chance of human error as the plurality of transaction conditions are complicated to understand and each offering has to be collated manually. Worse, some users discontinue the search because of a lack of time and complexity of the information regarding savings and purchase with an advertised store that causes a loss of potential savings from alternative transaction modes.

Accordingly, there remains a need of addressing the aforementioned technical problems using method for generating personalized recommendation by optimizing transaction mode for a product search.

### BRIEF DESCRIPTION OF THE DRAWINGS

The embodiments herein will be better understood from the following detailed description with reference to the drawings, in which:

FIG. 1 illustrates a system for generating a personalized recommendation that optimizes transaction mode for a product search according to some embodiments herein;

FIG. 2 illustrates an exploded view of a channel optimization server of FIG. 1 according to some embodiments herein;

FIG. 3 illustrates an interaction diagram for a method for generating a personalized recommendation that optimizes transaction mode for a product search according to some embodiments herein;

FIG. 4 is a flow diagram that illustrates a method for generating a personalized recommendation that optimizes transaction mode for a product search according to some embodiments herein; and

FIG. 5 is a representative hardware environment for practicing the embodiments herein with respect to FIGS. 1 through 4.

### SUMMARY

In view of the foregoing, according to a first aspect, there is provided a method for generating a personalized recommendation by optimizing transaction mode for a product search. The method comprising (a) automatically obtaining products data from a plurality of disparate product sources using software robotics process automation, wherein the products data includes a transaction channel, a product name, a product price, a product specification, a product availability, and a product deal, (b) extracting at least one contextual attribute from the products data using a natural language processing model based on a composite and contextual matching technique, (c) dynamically updating the products data by detecting at least one inconsistency in the products data using software robotics defect detection, (d) obtaining, from at least one user device associated with a user, a search query for a product, (e) generating a recommendation of a transaction mode for the product using a custom machine learning model, wherein the transaction mode is a combination of the transaction channel and a financial instrument associated with the user, wherein the recommendation is personalized by the custom machine learning model based on at least one of (i) a partial information of financial instruments associated with the user and (ii) a plurality of attributes of the user; and (f) representing the recommendation at the user device for optimizing search of the transaction mode for the product.

The method is of advantage that the method leverages machine learning heuristics to analyze uncorrelated and disparate data to determine composite mapping relations that improve the accuracy and relevance of the recommendation of the transaction mode. The method results in clear and curated information that is factually derived, enabling users to make informed decisions. Further, the method personalizes the transaction mode to the user, ensuring that recommendations are tailored to unique preferences of the user, budget constraints, and past purchase history. The personalized recommendations are presented in an easily consumable format, saving users time and effort by automating the process of searching for products and analyzing different options, leading to an improved overall user experience.

Further, the use of a custom machine learning model enables the method to continuously learn and adapt to user behavior, leading to improved recommendation accuracy over time. Additionally, the invention provides users with access to a wide range of disparate product sources, enabling them to find the best products at the best prices. The use of natural language processing and defect detection ensures that the products data used to generate recommendations is accurate and up-to-date. Users are enabled to easily verify and complete transactions using their preferred financial instruments, leading to a seamless end-to-end shopping experience. Overall, the personalized recommendations provided by the invention can help increase sales and revenue for retailers and e-commerce platforms by better matching user preferences with available products.

In some embodiments, automatically obtaining products data from a plurality of disparate product sources further comprises (a) automatically obtaining products data from the plurality of disparate product sources using software data scrapers, (b) interpreting and extracting relevant product data using a software text extractor, (c) extracting at least one contextual attribute from the products data using a natural language processing model based on a composite and contextual matching technique, (d) using robotic anomaly detection to detect and correct inconsistencies in the extracted product data, (e) using a robotic quality engine for data structure quality control to ensure the accuracy and completeness of the extracted data, (f) using a serverless processor and neural data streamer for data parsing and cleanup.

In some embodiments, the user is registered by capturing a personally identifiable information associated with the user at a graphical user interface (GUI) of the at least one user device, wherein the personally identifiable information includes a partial information of the financial instruments associated with the user.

In some embodiments, the partial information of the financial instruments is automatically obtained from a financial instrument data source upon authentication of the user using at least one user device.

In some embodiments, the custom machine learning model of step (e) of the first aspect is trained using a historical transaction data and preferences of the user.

In some embodiments, the custom machine learning model of step (e) of the first aspect is updated in real-time based on a response of the user to the recommendation.

In a second aspect, there is provided a system for generating a personalized recommendation by optimizing transaction mode for a product search, wherein the system comprises a channel optimization server that comprises a processor and a memory configured to perform (a) automatically obtaining products data from a plurality of disparate product sources using software robotics process automation, wherein the products data includes a transaction channel, a product name, a product price, a product specification, a product availability, and a product deal, (b) extracting at least one contextual attribute from the products data using a natural language processing model based on a composite and contextual matching technique, (c) dynamically updating the products data by detecting at least one inconsistency in the products data using software robotics defect detection, (d) obtaining, from at least one user device associated with a user, a search query for a product, (e) generating a recommendation of a transaction mode for the product using a custom machine learning model, wherein the transaction mode is a combination of the transaction channel and a financial instrument associated with the user, wherein the recommendation is personalized by the custom machine learning model based on at least one of (i) a partial information of financial instruments associated with the user and (ii) a plurality of attributes of the user; and (f) representing the recommendation at the user device for optimizing search of the transaction mode for the product.

The system is of advantage that the system leverages machine learning heuristics to analyze uncorrelated and disparate data to determine composite mapping relations that improve the accuracy and relevance of the recommendation of the transaction mode. The system results in clear and curated information that is factually derived, enabling users to make informed decisions. Further, the system personalizes the transaction mode to the user, ensuring that recommendations are tailored to unique preferences of the user, budget constraints, and past purchase history. The personalized recommendations are presented in an easily consumable format, saving users time and effort by automating the process of searching for products and analyzing different options, leading to an improved overall user experience.

Further, the use of a custom machine learning model enables the system to continuously learn and adapt to user behavior, leading to improved recommendation accuracy over time. Additionally, the invention provides users with access to a wide range of disparate product sources, enabling them to find the best products at the best prices. The use of natural language processing and defect detection ensures that the products data used to generate recommendations is accurate and up-to-date. Users are enabled to easily verify and complete transactions using their preferred financial instruments, leading to a seamless end-to-end shopping experience. Overall, the personalized recommendations provided by the invention can help increase sales and revenue for retailers and e-commerce platforms by better matching user preferences with available products.

In some embodiments, automatically obtaining products data from a plurality of disparate product sources further comprises (a) automatically obtaining products data from the plurality of disparate product sources using software data scrapers, (b) interpreting and extracting relevant product data using a software text extractor, (c) extracting at least one contextual attribute from the products data using a natural language processing model based on a composite and contextual matching technique, (d) using robotic anomaly detection to detect and correct inconsistencies in the extracted product data, (e) using a robotic quality engine for data structure quality control to ensure the accuracy and completeness of the extracted data, (f) using a serverless processor and neural data streamer for data parsing and cleanup.

In some embodiments, the user is registered by capturing a personally identifiable information associated with the user at a graphical user interface (GUI) of the at least one user device, wherein the personally identifiable information includes a partial information of the financial instruments associated with the user.

In some embodiments, the partial information of the financial instruments is automatically obtained from a financial instrument data source upon authentication of the user using at least one user device.

In some embodiments, the custom machine learning model of step (e) of the second aspect is trained using a historical transaction data and preferences of the user.

In some embodiments, the custom machine learning model of step (e) of the second aspect is updated in real-time based on a response of the user to the recommendation.

In a third aspect, there is provided one or more non-transitory computer-readable storage medium storing the one or more sequence of instructions, which when executed by the one or more processors, causes to perform a method for generating a personalized recommendation by optimizing transaction mode for a product search, the method comprising (a) automatically obtaining products data from a plurality of disparate product sources using software robotics process automation, wherein the products data includes a transaction channel, a product name, a product price, a product specification, a product availability, and a product deal, (b) extracting at least one contextual attribute from the products data using a natural language processing model based on a composite and contextual matching technique, (c) dynamically updating the products data by detecting at least one inconsistency in the products data using software robotics defect detection, (d) obtaining, from at least one user device associated with a user, a search query for a product, (e) generating a recommendation of a transaction mode for the product using a custom machine learning model, wherein the transaction mode is a combination of the transaction channel and a financial instrument associated with the user, wherein the recommendation is personalized by the custom machine learning model based on at least one of (i) a partial information of financial instruments associated with the user and (ii) a plurality of attributes of the user; and (f) representing the recommendation at the user device for optimizing search of the transaction mode for the product.

The one or more non-transitory computer-readable storage medium is of advantage that the one or more non-transitory computer-readable storage medium leverages machine learning heuristics to analyze uncorrelated and disparate data to determine composite mapping relations that improve the accuracy and relevance of the recommendation of the transaction mode. The one or more non-transitory computer-readable storage medium results in clear and curated information that is factually derived, enabling users to make informed decisions. Further, the one or more non-transitory computer-readable storage medium personalizes the transaction mode to the user, ensuring that recommendations are tailored to unique preferences of the user, budget constraints, and past purchase history. The personalized recommendations are presented in an easily consumable format, saving users time and effort by automating the process of searching for products and analyzing different options, leading to an improved overall user experience.

Further, the use of a custom machine learning model enables the one or more non-transitory computer-readable storage medium to continuously learn and adapt to user behavior, leading to improved recommendation accuracy over time. Additionally, the invention provides users with access to a wide range of disparate product sources, enabling them to find the best products at the best prices. The use of natural language processing and defect detection ensures that the products data used to generate recommendations is accurate and up-to-date. Users are enabled to easily verify and complete transactions using their preferred financial instruments, leading to a seamless end-to-end shopping experience. Overall, the personalized recommendations provided by the invention can help increase sales and revenue for retailers and e-commerce platforms by better matching user preferences with available products.

In some embodiments, automatically obtaining products data from a plurality of disparate product sources further comprises (a) automatically obtaining products data from the plurality of disparate product sources using software data scrapers, (b) interpreting and extracting relevant product data using a software text extractor, (c) extracting at least one contextual attribute from the products data using a natural language processing model based on a composite and contextual matching technique, (d) using robotic anomaly detection to detect and correct inconsistencies in the extracted product data, (e) using a robotic quality engine for data structure quality control to ensure the accuracy and completeness of the extracted data, (f) using a serverless processor and neural data streamer for data parsing and cleanup.

In some embodiments, the user is registered by capturing a personally identifiable information associated with the user at a graphical user interface (GUI) of the at least one user device, wherein the personally identifiable information includes a partial information of the financial instruments associated with the user.

In some embodiments, the partial information of the financial instruments is automatically obtained from a financial instrument data source upon authentication of the user using at least one user device.

In some embodiments, the custom machine learning model of step (e) of the third aspect is trained using a historical transaction data and preferences of the user.

In some embodiments, the custom machine learning model of step (e) of the third aspect is updated in real-time based on a response of the user to the recommendation.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In the view of the foregoing, the need for a method for generating a personalized recommendation by optimizing transaction mode for a product search is fulfilled in the ongoing description by (a) automatically obtaining products data from a plurality of disparate product sources using software robotics process automation, wherein the products data includes a transaction channel, a product name, a product price, a product specification, a product availability, and a product deal, (b) extracting at least one contextual attribute from the products data using a natural language processing model based on a composite and contextual matching technique, (c) dynamically updating the products data by detecting at least one inconsistency in the products data using software robotics defect detection, (d) obtaining, from at least one user device associated with a user, a search query for a product, (e) generating a recommendation of a transaction mode for the product using a custom machine learning model, wherein the transaction mode is a combination of the transaction channel and a financial instrument associated with the user, wherein the recommendation is personalized by the custom machine learning model based on at least one of (i) a partial information of financial instruments associated with the user and (ii) a plurality of attributes of the user; and (f) representing the recommendation at the user device for optimizing search of the transaction mode for the product.

The term “products data” refers to information related to products such as a transaction channel, product name, product price, product specification, product availability, and product deal. The term “disparate product sources” refers to multiple sources of products data that are not necessarily related to each other, such as data from different online retailers, manufacturers, or distributors. The term “transaction channel” refers to the method through which a user can purchase a product, such as online, in-store, or via user device. The term “contextual attribute” refers to a characteristic or feature of a product that provides additional context or information, such as color, size, or material. The term “composite and contextual matching technique” refers to a natural language processing technique that takes into account multiple contextual attributes of a product to better match it to a search query of the user. The term “transaction mode” refers to the combination of the transaction channel and a financial instrument used by a user to purchase a product, such as a credit card or PayPal account.

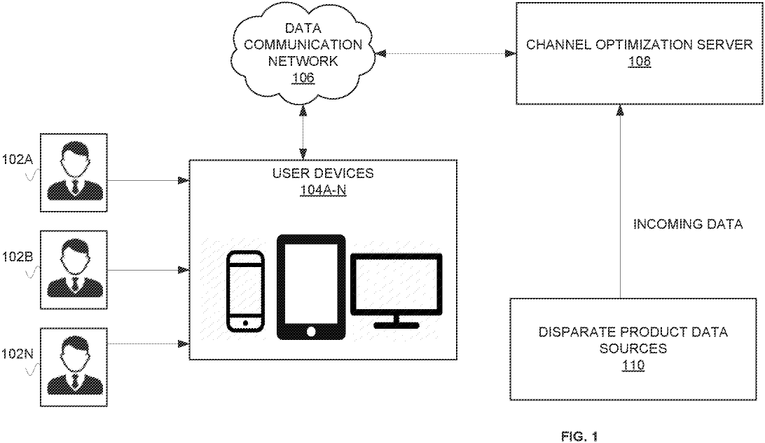

Referring now to the drawings, and more particularly to FIGS. 1 through 5, where similar reference characters denote corresponding features in a consistent manner throughout the figures, there are shown preferred embodiments.

FIG. 1 illustrates a system for generating a personalized recommendation by optimizing transaction mode for a product search according to some embodiments herein. The system 100 includes a plurality of users 102A-N that are associated with user devices 104A-N, a data communication network 106 and a channel optimization server 108 and a plurality of disparate product data sources 110. The user devices 104A-N and the channel optimization server 108 are communicatively connected with each other via the data communication network 106. The data communication network 106 may be one or more of a wired network, a wireless network, a combination of the wired network and the wireless network or the Internet. The user devices 104A-N include, but are not limited to, a mobile device, a smartphone, a smart watch, a notebook, a Global Positioning System (GPS) device, a tablet, a desktop computer, a laptop or any network enabled device. The channel optimization server 108 may automatically obtaining products data from a plurality of disparate product sources using software robotics process automation. The products data includes a transaction channel, a product name, a product price, a product specification, a product availability, and a product deal. The channel optimization server 108 extracts one or more contextual attributes from the products data using a natural language processing model based on a composite and contextual matching technique. The channel optimization server 108 dynamically updating the products data by detecting one or more inconsistencies in the products data using software robotics defect detection. The channel optimization server 108 obtains from a user device 104A associated with a user 102A, a search query for a product. The channel optimization server 108 generates a recommendation of a transaction mode for the product using a custom machine learning model. The transaction mode is a combination of the transaction channel and a financial instrument associated with the user. The recommendation is personalized by the custom machine learning model based on one or more of (i) a partial information of financial instruments associated with the user 102A and (ii) a plurality of attributes of the user 102A. The channel optimization server 108 represents the recommendation at the user device 104A for optimizing search of the transaction mode for the product.

As an example, the user searches for a specific product, such as a laptop, on an online website. The channel optimization server 108 obtains products data from multiple sources and extracts contextual attributes such as the laptop’s brand, model, specifications, and price. The channel optimization server 108 then analyzes the user’s past purchase history, browsing behavior, and location to generate a personalized recommendation of the optimal transaction mode, such as recommending a credit card associated with the user with cashback offers.

The system 100 is of advantage that the system 100 leverages machine learning heuristics to analyze uncorrelated and disparate data to determine composite mapping relations that improve the accuracy and relevance of the recommendation of the transaction mode. The system 100 results in clear and curated information that is factually derived, enabling users to make informed decisions. Further, the system 100 personalizes the transaction mode to the user, ensuring that recommendations are tailored to unique preferences of the user, budget constraints, and past purchase history. The personalized recommendations are presented in an easily consumable format, saving users time and effort by automating the process of searching for products and analyzing different options, leading to an improved overall user experience.

Further, the use of a custom machine learning model enables the system 100 to continuously learn and adapt to user behavior, leading to improved recommendation accuracy over time. Additionally, the invention provides users with access to a wide range of disparate product sources, enabling them to find the best products at the best prices. The use of natural language processing and defect detection ensures that the products data used to generate recommendations is accurate and up-to-date. Users are enabled to easily verify and complete transactions using their preferred financial instruments, leading to a seamless end-to-end shopping experience. Overall, the personalized recommendations provided by the invention can help increase sales and revenue for retailers and e-commerce platforms by better matching user preferences with available products.

In some embodiments, automatically obtaining products data from a plurality of disparate product sources 110 further includes (a) automatically obtaining products data from the plurality of disparate product sources 110 using software data scrapers, (b) interpreting and extracting relevant product data using a software text extractor, (c) extracting one or more contextual attribute from the products data using a natural language processing model based on a composite and contextual matching technique, (d) using robotic anomaly detection to detect and correct inconsistencies in the extracted product data, (e) using a robotic quality engine for data structure quality control to ensure the accuracy and completeness of the extracted data, (f) using a serverless processor and neural data streamer for data parsing and cleanup.

In some embodiments, the user is registered by capturing a personally identifiable information associated with the user at a graphical user interface (GUI) of the one or more user devices 102A-N. The personally identifiable information includes a partial information of the financial instruments associated with the user.

In some embodiments, the partial information of the financial instruments is automatically obtained from a financial instrument data source upon authentication of the user using one or more user devices 102A-N.

In some embodiments, the custom machine learning model is trained using a historical transaction data and preferences of the user.

In some embodiments, the custom machine learning model is updated in real-time based on a response of the user to the recommendation.

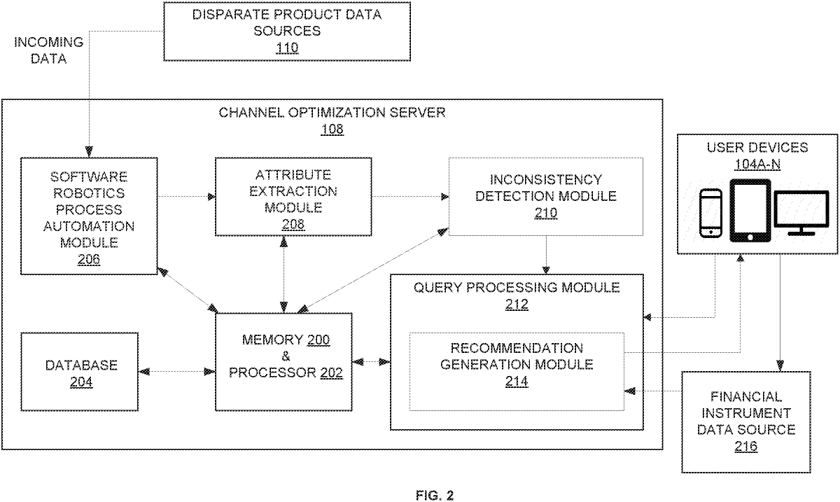

FIG. 2 illustrates an exploded view of a channel optimization server 108 of FIG. 1 according to some embodiments herein. The channel optimization server 108 includes a memory 200 and a processor 202 that are connected to a database 204, a robotic process automation module 206, an attribute extraction module 208, an inconsistency detection module 210, a query processing module 212 that includes a recommendation generation module 214 and a financial instrument data source 216.

The robotic process automation module 206 automatically obtains products data from a plurality of disparate product sources using software robotics process automation. The products data includes a transaction channel, a product name, a product price, a product specification, a product availability, and a product deal. The robotic process automation module 206 may extract information across multiple data sources using custom software robotics process automation bots that are trained with a custom-built template and script. The products data may be obtained using an application programming interface.

The attribute extraction module 208 extracts one or more contextual attributes from the products data using a natural language processing model based on a composite and contextual matching technique. The one or more contextual attributes may be verified and read for consistency using robotic text extractor whilst being parsed through a data stream into the database 204. The inconsistency detection module 210 dynamically updates the products data by detecting one or more inconsistencies in the products data using robotic defect detection. An inconsistency in the products data refers to conflicting information about a price of the product, availability of the product, or specifications from the disparate product sources, that can potentially cause conflicts or errors in the recommendation. Software robots may be used to automatically detect and report errors or inconsistencies in products data. For example, the inconsistency detection module 210 may use software robots to check the products data obtained from the disparate product sources 110 and flag inconsistencies or errors, such as conflicting information about availability of a product or price of a product.

The query processing module 212 obtains from a user device 104A associated with a user 102A, a search query for a product. In some embodiments, the anomaly detection module 210 dynamically updates the products data multiple times in a day. In some embodiments, the products data may be parsed using a natural language processing model for applicability use-cases. In some embodiments, the products data may be verified for quality using a software robotics quality engine.

The recommendation generation module 214 generates a recommendation of a transaction mode for the product using a custom machine learning model. The transaction mode is a combination of the transaction channel and a financial instrument associated with the user. The recommendation is personalized by the custom machine learning model based on one or more of (i) a partial information of financial instruments associated with the user 102A and (ii) a plurality of attributes of the user 102A. The plurality of attributes of the user may include, but are not limited to, age, gender, geo-location. In some embodiments, the plurality of attributes of the user includes a demographic.

In some embodiments, the recommendation generation module 214 may be used to generate predictive insights around competitor pricing, product lifecycle pricing and behavioral patterns of a customer.

The recommendation is represented at the user device 104A for optimizing search of the transaction mode for the product. The recommendation is represented at the user device in a simple to consume format that enables effective decision making for the user while making a purchase for a product. On end user access of specific products, pertinent information specific to user utilizing specifics such as financial instruments, geolocation and product availability is utilized to compute result listing that is represented in an easy to consume and friendly format.

In some embodiments, automatically obtaining products data from a plurality of disparate product sources 110 further includes (a) automatically obtaining products data from the plurality of disparate product sources 110 using software data scrapers, (b) interpreting and extracting relevant product data using a software text extractor, (c) extracting one or more contextual attributes from the products data using a natural language processing model based on a composite and contextual matching technique, (d) using robotic anomaly detection to detect and correct inconsistencies in the extracted product data, (e) using a robotic quality engine for data structure quality control to ensure the accuracy and completeness of the extracted data, (f) using a serverless processor and neural data streamer for data parsing and cleanup.

In some embodiments, the user is registered by capturing a personally identifiable information associated with the user at a graphical user interface (GUI) of the one or more user devices 102A-N. The personally identifiable information includes a partial information of the financial instruments associated with the user. Personally identifiable information (PII) may refer to any information that can be used to identify a user. PII may include one or more of the following: a name of the user, an address, a date of birth, an email address, a phone number, a social security number, a driver’s license number, a passport number, or a financial instrument detail. Partial information of the financial instrument refers to a subset of data associated with a financial instrument that is used for payment purposes by the user. Partial information of the financial instrument may include first few digits of a debit or credit card, such as the first 6 digits, which are also known as the bank identification number (BIN) or issuer identification number (IIN). Partial information of the financial instrument may also include other identifying information such as the cardholder’s name or the card expiration date. In some embodiments, the partial information of financial instrument is used to validate a financial instrument of the user and personalize recommendations for transaction modes.

In some embodiments, the partial information of the financial instruments is automatically obtained from the financial instrument data source 216 upon authentication of the user using one or more user devices 102A-N. The financial instrument data source 216 may be a database or repository that includes information related to the financial instruments including payment methods, numbers, expiration dates, and other relevant information. The financial instrument data source may be owned or operated by a financial institution, such as a bank or payment processing company, or it may be a third-party provider that specializes in providing data related to financial instruments.

In some embodiments, the custom machine learning model is trained using a historical transaction data and preferences of the user.

In some embodiments, the custom machine learning model is updated in real-time based on a response of the user to the recommendation. After the channel optimization server 108 generates a personalized recommendation, the user selects a transaction mode and makes a purchase. The channel optimization server 108 tracks behavior of the user and feedback of the user after the purchase and updates the custom machine learning model in real-time to improve future recommendations. For instance, if the user selects a different transaction mode than the one recommended by the channel optimization server 108, the channel optimization server 108 may update the model to better understand preferences of the user.

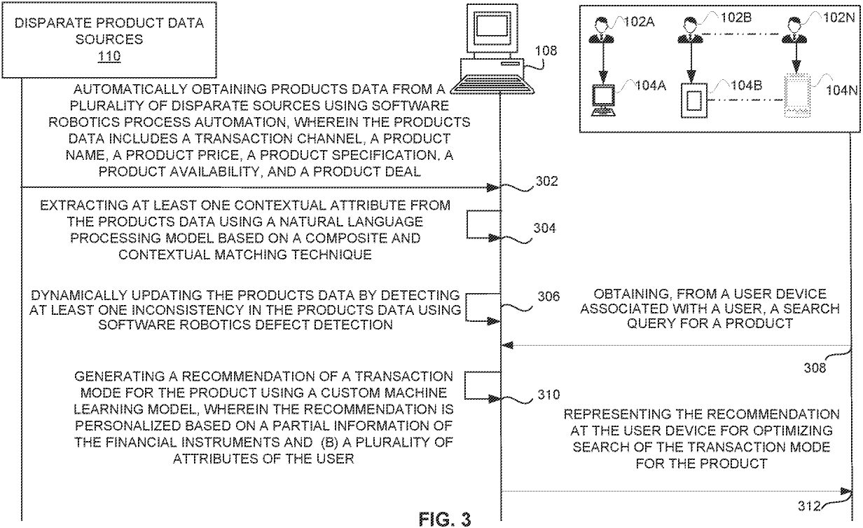

FIG. 3 illustrates an interaction diagram for a method for generating a personalized recommendation by optimizing transaction mode for a product search according to some embodiments herein. At step 302, products data is automatically obtained from a plurality of disparate product sources using software robotics process automation, wherein the products data includes a transaction channel, a product name, a product price, a product specification, a product availability, and a product deal. At step 304, at least one contextual attribute is extracted from the products data using a natural language processing model based on a composite and contextual matching technique. At step 306, the products data is dynamically updated by detecting at least one inconsistency in the products data using robotic defect detection. At step 308, a search query for a product is obtained from a user device 104A associated with a user 102A. At step 310, a recommendation of a transaction mode for the product is generated using a custom machine learning model, wherein the transaction mode is a combination of the transaction channel and a financial instrument associated with the user, wherein the recommendation is personalized by the custom machine learning model based on at least one of (i) a partial information of financial instruments associated with the user and (ii) a plurality of attributes of the user. At step 312, the recommendation is represented at the user device 104A for optimizing search of the transaction mode for the product.

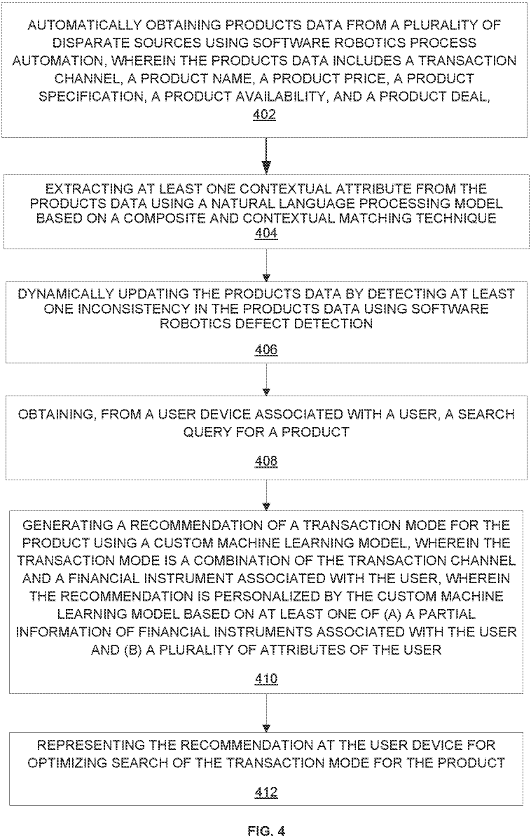

FIG. 4 is a flow diagram that illustrates a method for generating a personalized recommendation by optimizing transaction mode for a product search according to some embodiments herein. At step 402, the method includes automatically obtaining products data from a plurality of disparate product sources using software robotics process automation, wherein the products data includes a transaction channel, a product name, a product price, a product specification, a product availability, and a product deal. At step 404, the method includes extracting at least one contextual attribute from the products data using a natural language processing model based on a composite and contextual matching technique. At step 406, the method includes dynamically updating the products data by detecting at least one inconsistency in the products data using robotic defect detection. At step 408, the method includes obtaining, from a user device associated with a user, a search query for a product. At step 410, the method includes generating a recommendation of a transaction mode for the product using a custom machine learning model, wherein the transaction mode is a combination of the transaction channel and a financial instrument associated with the user, wherein the recommendation is personalized by the custom machine learning model based on at least one of (i) a partial information of financial instruments associated with the user and (ii) a plurality of attributes of the user. At step 412, the method includes representing the recommendation at the user device for optimizing search of the transaction mode for the product.

The method is of advantage that the method leverages machine learning heuristics to analyze uncorrelated and disparate data to determine composite mapping relations that improve the accuracy and relevance of the recommendation of the transaction mode. The method results in clear and curated information that is factually derived, enabling users to make informed decisions. Further, the method personalizes the transaction mode to the user, ensuring that recommendations are tailored to unique preferences of the user, budget constraints, and past purchase history. The personalized recommendations are presented in an easily consumable format, saving users time and effort by automating the process of searching for products and analyzing different options, leading to an improved overall user experience.

Further, the use of a custom machine learning model enables the method to continuously learn and adapt to user behavior, leading to improved recommendation accuracy over time. Additionally, the invention provides users with access to a wide range of disparate product sources, enabling them to find the best products at the best prices. The use of natural language processing and defect detection ensures that the products data used to generate recommendations is accurate and up-to-date. Users are enabled to easily verify and complete transactions using their preferred financial instruments, leading to a seamless end-to-end shopping experience. Overall, the personalized recommendations provided by the invention can help increase sales and revenue for retailers and e-commerce platforms by better matching user preferences with available products.

In some embodiments, automatically obtaining products data from a plurality of disparate product sources further includes (a) automatically obtaining products data from the plurality of disparate product sources using software data scrapers, (b) interpreting and extracting relevant product data using a software text extractor, (c) extracting at least one contextual attribute from the products data using a natural language processing model based on a composite and contextual matching technique, (d) using robotic anomaly detection to detect and correct inconsistencies in the extracted product data, (e) using a robotic quality engine for data structure quality control to ensure the accuracy and completeness of the extracted data, (f) using a serverless processor and neural data streamer for data parsing and cleanup.

In some embodiments, the user is registered by capturing a personally identifiable information associated with the user at a graphical user interface (GUI) of the at least one user device, wherein the personally identifiable information includes a partial information of the financial instruments associated with the user.

In some embodiments, the partial information of the financial instruments is automatically obtained from a financial instrument data source upon authentication of the user using at least one user device.

In some embodiments, the custom machine learning model of step (e) of the method is trained using a historical transaction data and preferences of the user.

In some embodiments, the custom machine learning model of step (e) of the method is updated in real-time based on a response of the user to the recommendation.

The various systems and corresponding components described herein and/or illustrated in the figures may be embodied as hardware-enabled modules and may be a plurality of overlapping or independent electronic circuits, devices, and discrete elements packaged onto a circuit board to provide data and signal processing functionality within a computer. An example might be a comparator, inverter, or flip-flop, which could include a plurality of transistors and other supporting devices and circuit elements. The systems that include electronic circuits process computer logic instructions capable of providing digital and/or analog signals for performing various functions as described herein. The various functions can further be embodied and physically saved as any of data structures, data paths, data objects, data object models, object files, database components. For example, the data objects could include a digital packet of structured data. Example data structures may include any of an array, tuple, map, union, variant, set, graph, tree, node, and an object, which may be stored and retrieved by computer memory and may be managed by processors, compilers, and other computer hardware components. The data paths can be part of a computer CPU or GPU that performs operations and calculations as instructed by the computer logic instructions. The data paths could include digital electronic circuits, multipliers, registers, and buses capable of performing data processing operations and arithmetic operations (e.g., Add, Subtract, etc.), bitwise logical operations (AND, OR, XOR, etc.), bit shift operations (e.g., arithmetic, logical, rotate, etc.), complex operations (e.g., using single clock calculations, sequential calculations, iterative calculations, etc.). The data objects may be physical locations in computer memory and can be a variable, a data structure, or a function. Some examples of the modules include relational databases (e.g., such as Oracle^{®} relational databases), and the data objects can be a table or column, for example. Other examples include specialized objects, distributed objects, object-oriented programming objects, and semantic web objects. The data object models can be an application programming interface for creating HyperText Markup Language (HTML) and Extensible Markup Language (XML) electronic documents. The models can be any of a tree, graph, container, list, map, queue, set, stack, and variations thereof, according to some examples. The data object files can be created by compilers and assemblers and contain generated binary code and data for a source file. The database components can include any of tables, indexes, views, stored procedures, and triggers.

In an example, the embodiments herein can provide a computer program product configured to include a pre-configured set of instructions, which when performed, can result in actions as stated in conjunction with various figures herein. In an example, the pre-configured set of instructions can be stored on a tangible non-transitory computer readable medium. In an example, the tangible non-transitory computer readable medium can be configured to include the set of instructions, which when performed by a device, can cause the device to perform acts similar to the ones described here.

The embodiments herein may also include tangible and/or non-transitory computer-readable storage media for carrying or having computer-executable instructions or data structures stored thereon. Such non-transitory computer readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a special purpose computer or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

The techniques provided by the embodiments herein may be implemented on an integrated circuit chip (not shown). The chip design is created in a graphical computer programming language and stored in a computer storage medium (such as a disk, tape, physical hard drive, or virtual hard drive such as in a storage access network. If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher-level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

Furthermore, the embodiments herein can take the form of a computer program product accessible from a computer-usable or computer-readable medium providing program code for use by or in connection with a computer or any instruction execution system. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk - read only memory (CD-ROM), compact disk - read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

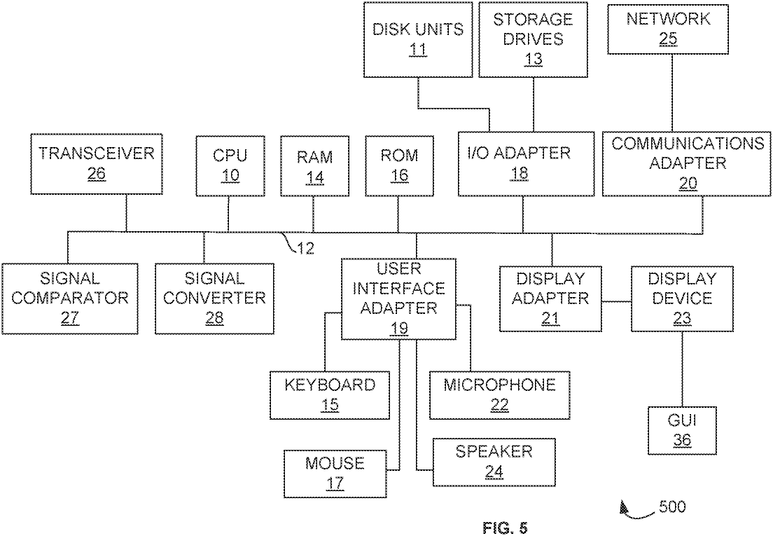

A representative hardware environment for practicing the embodiments herein is depicted in FIG. 5, with reference to FIGS. 1 through 4. This schematic drawing illustrates a hardware configuration of a software development device /computer system 500 in accordance with the embodiments herein. The system 500 comprises at least one processor or central processing unit (CPU) 10. The CPUs 10 are interconnected via system bus 12 to various devices such as a random-access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system 500 can read the inventive instructions on the program storage devices and follow these instructions to execute the methodology of the embodiments herein. The system 500 further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network, and a display adapter 21 connects the bus 12 to a display device 23, which provides a graphical entity interface (GUI) 36 of the output data in accordance with the embodiments herein, or which may be embodied as an output device such as a monitor, printer, or transmitter, for example. Further, a transceiver 26, a signal comparator 27, and a signal converter 28 may be connected with the bus 12 for processing, transmission, receipt, comparison, and conversion of electric signals.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

What is claimed is:

1. A method for generating a personalized recommendation by optimizing transaction mode for a product search, said method comprising:
(a) automatically obtaining products data from a plurality of disparate product sources using software robotics process automation, wherein the products data includes a transaction channel, a product name, a product price, a product specification, a product availability, and a product deal;
(b) extracting at least one contextual attribute from the products data using a natural language processing model based on a composite and contextual matching technique;
(c) dynamically updating the products data by detecting at least one inconsistency in the products data using software robotics defect detection;
(d) obtaining, from at least one user device associated with a user, a search query for a product;
(e) generating a recommendation of a transaction mode for the product using a custom machine learning model, wherein the transaction mode is a combination of the transaction channel and a financial instrument associated with the user, wherein the recommendation is personalized by the custom machine learning model based on at least one of (i) a partial information of financial instruments associated with the user and (ii) a plurality of attributes of the user; and
(f) representing the recommendation at the user device for optimizing search of the transaction mode for the product.

2. The method as claimed in claim 1, wherein automatically obtaining products data from a plurality of disparate product sources further comprises:
automatically obtaining products data from the plurality of disparate product sources using software data scrapers;
interpreting and extracting relevant product data using a software text extractor;
extracting at least one contextual attribute from the products data using a natural language processing model based on a composite and contextual matching technique;
using robotic anomaly detection to detect and correct inconsistencies in the extracted product data;
using a robotic quality engine for data structure quality control to ensure the accuracy and completeness of the extracted data; and
using a serverless processor and neural data streamer for data parsing and cleanup.

3. The method as claimed in claim 1, wherein the user is registered by capturing a personally identifiable information associated with the user at a graphical user interface (GUI) of the at least one user device, wherein the personally identifiable information includes a partial information of the financial instruments associated with the user.

4. The method as claimed in claim 3, wherein the partial information of the financial instruments is automatically obtained from a financial instrument data source upon authentication of the user using at least one user device.

5. The method as claimed in claim 1, further comprising training the custom machine learning model of step (e) using a historical transaction data and preferences of the user.

6. The method as claimed in claim 1, wherein the custom machine learning model of step (e) is updated in real-time based on a response of the user to the recommendation.

7. A system for generating a personalized recommendation by optimizing transaction mode for a product search, wherein the system comprises:
a channel optimization server that comprises a processor and a memory that are configured to perform:
(a) automatically obtaining products data from a plurality of disparate product sources using software robotics process automation, wherein the products data includes a transaction channel, a product name, a product price, a product specification, a product availability, and a product deal;
(b) extracting at least one contextual attribute from the products data using a natural language processing model based on a composite and contextual matching technique;
(c) dynamically updating the products data by detecting at least one inconsistency in the products data using software robotics defect detection;
(d) obtaining, from at least one user device associated with a user, a search query for a product;
(e) generating a recommendation of a transaction mode for the product using a custom machine learning model, wherein the transaction mode is a combination of the transaction channel and a financial instrument associated with the user, wherein the recommendation is personalized by the custom machine learning model based on at least one of (i) a partial information of financial instruments associated with the user and (ii) a plurality of attributes of the user; and
(f) representing the recommendation at the user device for optimizing search of the transaction mode for the product.

8. The system as claimed in claim 7, wherein automatically obtaining products data from a plurality of disparate product sources further comprises:
automatically obtaining products data from the plurality of disparate product sources using software data scrapers;
interpreting and extracting relevant product data using a software text extractor;
extracting at least one contextual attribute from the products data using a natural language processing model based on a composite and contextual matching technique;
using robotic anomaly detection to detect and correct inconsistencies in the extracted product data;
using a robotic quality engine for data structure quality control to ensure the accuracy and completeness of the extracted data; and
using a serverless processor and neural data streamer for data parsing and cleanup.

9. The system as claimed in claim 7, wherein the user is registered by capturing a personally identifiable information associated with the user at a graphical user interface (GUI) of the at least one user device, wherein the personally identifiable information includes a partial information of the financial instruments associated with the user.

10. The system as claimed in claim 9, wherein the partial information of the financial instruments is automatically obtained from a financial instrument data source upon authentication of the user using at least one user device.

11. The system as claimed in claim 7, wherein the channel optimization server further trains the custom machine learning model of step (e) using a historical transaction data and preferences of the user.

12. The system as claimed in claim 7, wherein the custom machine learning model of step (e) is updated in real-time based on a response of the user to the recommendation.

13. One or more non-transitory computer-readable storage medium storing the one or more sequence of instructions, which when executed by the one or more processors, causes to perform a method for generating a personalized recommendation by optimizing transaction mode for a product search comprising:
(a) automatically obtaining products data from a plurality of disparate product sources using software robotics process automation, wherein the products data includes a transaction channel, a product name, a product price, a product specification, a product availability, and a product deal;
(b) extracting at least one contextual attribute from the products data using a natural language processing model based on a composite and contextual matching technique;
(c) dynamically updating the products data by detecting at least one inconsistency in the products data using software robotics defect detection;
(d) obtaining, from at least one user device associated with a user, a search query for a product;
(e) generating a recommendation of a transaction mode for the product using a custom machine learning model, wherein the transaction mode is a combination of the transaction channel and a financial instrument associated with the user, wherein the recommendation is personalized by the custom machine learning model based on at least one of (i) a partial information of financial instruments associated with the user and (ii) a plurality of attributes of the user; and
(f) representing the recommendation at the user device for optimizing search of the transaction mode for the product.

14. The one or more non-transitory computer-readable storage medium of claim 13, wherein automatically obtaining products data from a plurality of disparate product sources further comprises:
automatically obtaining products data from the plurality of disparate product sources using software data scrapers;
interpreting and extracting relevant product data using a software text extractor;
extracting at least one contextual attribute from the products data using a natural language processing model based on a composite and contextual matching technique;
using robotic anomaly detection to detect and correct inconsistencies in the extracted product data;
using a robotic quality engine for data structure quality control to ensure the accuracy and completeness of the extracted data; and
using a serverless processor and neural data streamer for data parsing and cleanup.

15. The one or more non-transitory computer-readable storage medium of claim 13, wherein the user is registered by capturing a personally identifiable information associated with the user at a graphical user interface (GUI) of the at least one user device, wherein the personally identifiable information includes a partial information of the financial instruments associated with the user.

16. The one or more non-transitory computer-readable storage medium of claim 15, wherein the partial information of the financial instruments is automatically obtained from a financial instrument data source upon authentication of the user using at least one user device.

17. The one or more non-transitory computer-readable storage medium of claim 13, further comprising training the custom machine learning model of step (e) using a historical transaction data and preferences of the user.

18. The one or more non-transitory computer-readable storage medium of claim 13, wherein the custom machine learning model of step (e) is updated in real-time based on a response of the user to the recommendation.
